(19) United States
(12) Patent Application Publication
(10) Pub. No.: US 2013/0124872 A1
(43) Pub. Date: May 16, 2013

(54) Method of accessing a computer hardware device in a Metro user interface mode application

(71) Applicants: MingXiang Shen, Hangzhou City (CN); YaGuang Xie, Hangzhou City (CN)

(72) Inventors: MingXiang Shen, Hangzhou City (CN); YaGuang Xie, Hangzhou City (CN)

(21) Appl. No.: 13/296,246

(22) Filed: Nov. 15, 2011

(51) Int. Cl. G06F 21/00; G06F 3/00; G06F 9/46

(52) U.S. Cl. 713/189; 719/313

(57) ABSTRACT

A method of accessing a hardware device in a computer includes executing a Metro user interface mode application in an operating system and executing a Desktop mode application in the operating system, the Desktop mode application corresponding to the Metro user interface mode application, and the Desktop mode application having permission to access a hardware device of the computer that the Metro user interface mode application does not have permission to access. The method also includes the Metro user interface mode application sending commands to the Desktop mode application through a network application programming interface, and the Desktop mode application sending the commands to the hardware device for controlling the hardware device with the commands, and the Desktop mode application receiving data from the hardware device and transferring the received data to the Metro user interface mode application.

### BACKGROUND OF THE INVENTION

1. Field of the Invention

The invention relates to a computer containing the Windows 8 operating system, and more particularly, to a method of accessing a computer hardware device in a Metro user interface mode application running in the Windows 8 operating system.

2. Description of the Prior Art

In September 2011 the Microsoft Corporation exhibited a first build version of the Windows 8 operating system and revealed two user interface modes of the Windows 8 operating system. The first user interface mode is the traditional Desktop mode and the second user interface mode is called the Metro user interface mode. Accordingly, in the Desktop mode, Desktop style applications are run, and in the Metro user interface mode, Metro style applications are run. The Metro style applications have many advantages such as the clean and simple appearance of the applications and the fact that the Metro style applications are designed with touch input in mind.

Please refer to FIG. 1 and FIG. 2. FIG. 1 is a screen 50 showing the Desktop mode according to the prior art. The screen 50 shows background wallpaper 52 for the Desktop mode, an open window 54, as well as a plurality of icons 56 shown on the background wallpaper 52. FIG. 2 is a screen 70 showing the Metro user interface mode according to the prior art. The screen 70 shows background wallpaper 72 for the Desktop mode, as well as a plurality of tiles 74 shown on the background wallpaper 72. Metro style applications may each be represented by their own tiles 74.

However, there are also many restrictions put on the Metro style applications. For instance, Metro style applications have restricted access to certain non-generic devices, such as optical disc drives, TV tuner cards, and other peripheral devices. Even if the computer system is equipped with the appropriate device drivers, the Metro style applications still have no direct access to these hardware devices. This lack of hardware access leads to great difficulty for application software developers wanting to write applications that run in the Metro user interface mode which will access the computer system's optical disc drive or TV tuner card. Thus, there is a need for a way to provide Metro style applications with the ability to access hardware devices of the computer system.

### SUMMARY OF THE INVENTION

It is therefore one of the primary objectives of the claimed invention to provide a method of accessing a hardware device in a computer and a related computer for providing access to a hardware device in the computer.

According to an exemplary embodiment of the claimed invention, a method of accessing a hardware device in a computer is disclosed. The method includes executing a Metro user interface mode application in an operating system and executing a Desktop mode application in the operating system, the Desktop mode application corresponding to the Metro user interface mode application, and the Desktop mode application having permission to access a hardware device of the computer that the Metro user interface mode application does not have permission to access. The method also includes the Metro user interface mode application sending commands to the Desktop mode application through a network application programming interface (API), and the Desktop mode application sending the commands to the hardware device for controlling the hardware device with the commands, and the Desktop mode application receiving data from the hardware device and transferring the received data to the Metro user interface mode application.

According to another exemplary embodiment of the claimed invention, a computer for providing access to a hardware device in the computer includes a memory, a hardware device, and an operating system of the computer stored in the memory. A user interface of the operating system includes a Metro user interface mode application and a Desktop mode application, the Desktop mode application corresponding to the Metro user interface mode application, and the Desktop mode application having permission to access the hardware device that the Metro user interface mode application does not have permission to access. The computer also includes a processor executing the Metro user interface mode application, executing the Desktop mode application, controlling the Metro user interface mode application to send commands to the Desktop mode application through a network application programming interface (API), controlling the Desktop mode application to send the commands to the hardware device for controlling the hardware device with the commands, and controlling the Desktop mode application to receive data from the hardware device and transfer the received data to the Metro user interface mode application.

It is an advantage that the present invention provides the Desktop mode application that corresponds to the Metro user interface mode application. The Desktop mode application has permission to access hardware devices which the Metro user interface mode application does not have permission to access. Therefore, the Metro user interface mode application can access the hardware devices of the computer through the corresponding Desktop mode application.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a screen showing a Desktop mode according to the prior art.

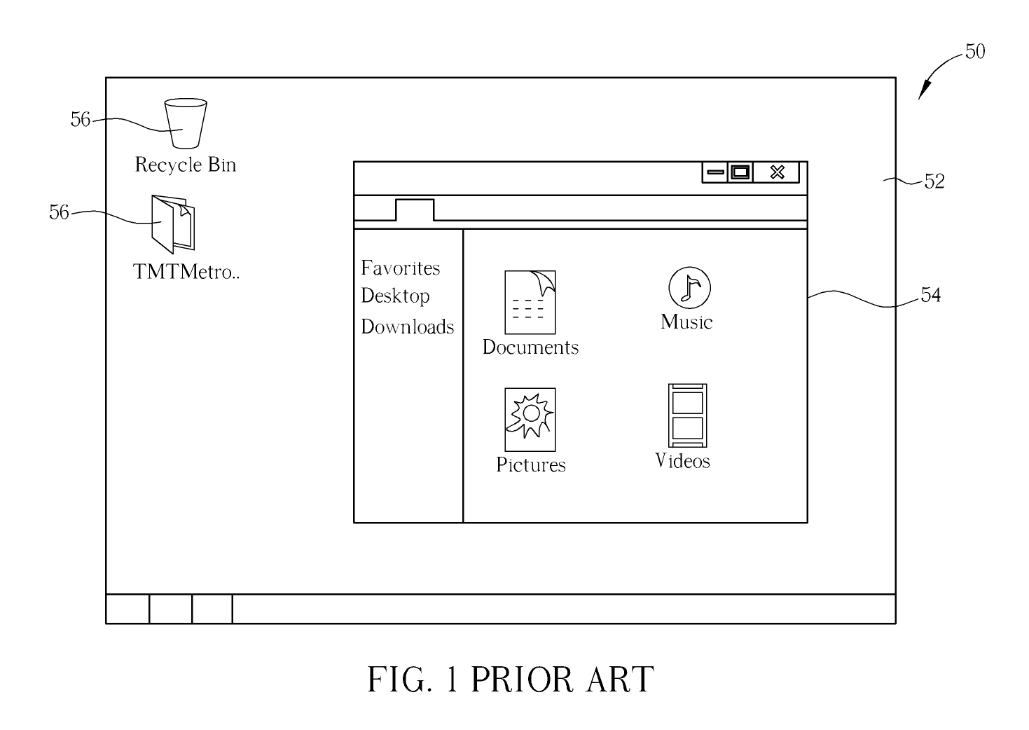

FIG. 2 is a screen showing a Metro user interface mode according to the prior art.

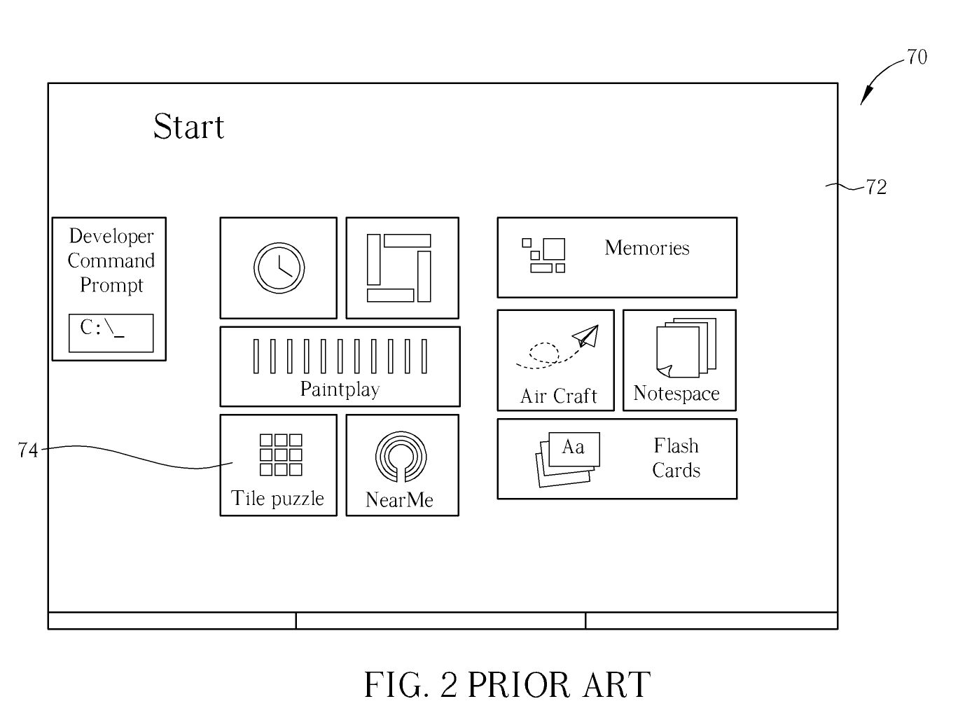

FIG. 3 is a block diagram of a computer containing a hardware device according to the present invention.

FIG. 4 is a diagram showing software layers of the Windows 8 operating system.

### DETAILED DESCRIPTION

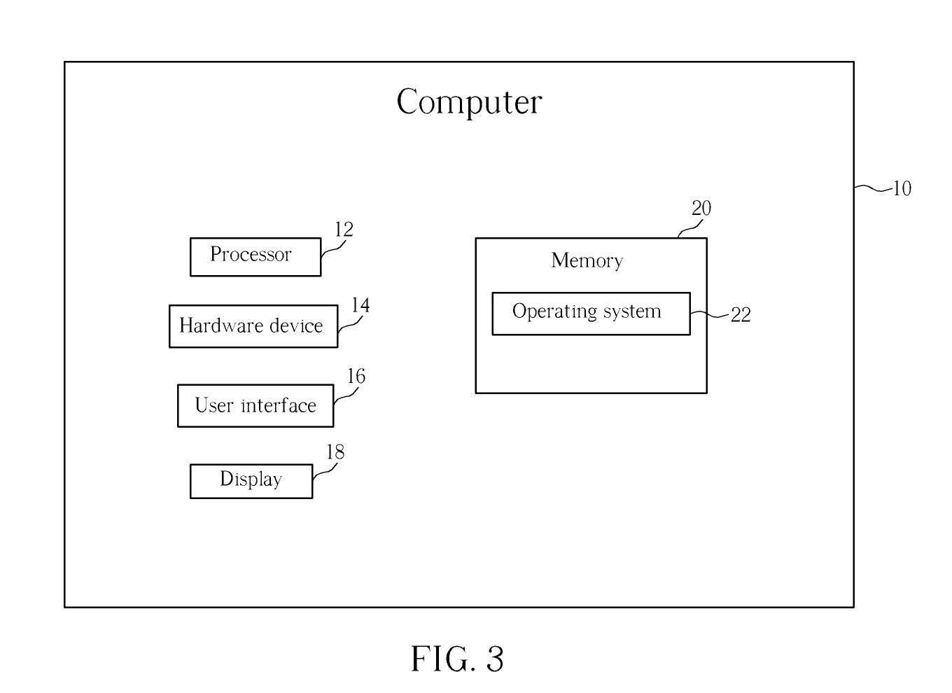

Please refer to FIG. 3. FIG. 3 is a block diagram of a computer 10 containing a hardware device 14 according to the present invention. The computer 10 also contains a processor 12 for controlling operation of the computer 10, a user interface 16 for receiving commands from a user, a display 18 for displaying data to a user, and a memory 20. The memory 20 is used to store an operating system 22, such as the Windows 8 operating system produced by the Microsoft Corporation. The operating system 22 is composed of software instructions executed by the processor 12.

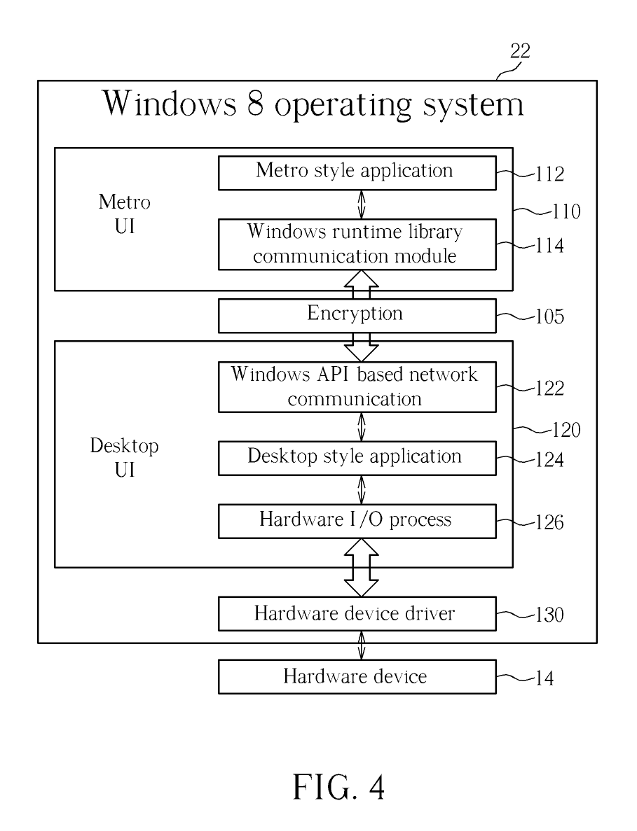

Please refer to FIG. 4. FIG. 4 is a diagram showing software layers of the Windows 8 operating system 22. The Windows 8 operating system 22 supports both a Metro user interface 110 and a Desktop user interface 120, and interacts with the hardware device 14 through a hardware device driver 130. The Metro user interface 110 contains a Metro style application 112 and the Desktop user interface 120 contains a Desktop style application 124. The Metro style application 112 communicates with the Desktop style application 124 through a Windows runtime library communication module 114 in the Metro user interface 110 and a Windows application programming interface (API) based network communication module 122 in the Desktop user interface 120. Data transmitted between the Metro user interface 110 and the Desktop user interface 120 may be encrypted through an encryption step 105 to protect sensitive data from being seen by unauthorized parties. The Desktop style application 124 interfaces with the hardware device driver 130 through a hardware input/output process 126.

The present invention takes an innovative approach for providing the Metro style application 112 with access to restricted hardware such as the hardware device 14. With the present invention approach, application software developers can develop Metro style applications such as the Metro style application 112 that have access to the hardware device 14 and other hardware devices such as the computer system's optical disc drive, TV tuner card, additional peripheral devices, and so forth. Therefore, with the present invention method, not only can the Desktop style application 124 access the hardware device 14, but the Metro style application 112 can access the hardware device 14 as well.

The Desktop style application 124 runs in the Desktop user interface 120, however, the Desktop style application 124 does not need to contain an actual user interface. Instead, the Desktop style application 124 can simply be run in the background. Nevertheless, since the Desktop style application 124 is running in the Desktop user interface 120, the Desktop style application 124 can access a variety of hardware device drivers 130 for corresponding hardware devices 14 such as a DVD player.

After running the Desktop style application 124, the Windows API based network communication module 122 such as the Socket API, can be used to create a local loop (loopback) socket whose purpose is to listen on a network port to receive commands from the Metro style application 112 running in the Metro user interface 110 that corresponds to the Desktop style application 124 running in the Desktop user interface 120. The Desktop style application 124 receives commands from the Metro style application 112, such as a command to start reading a DVD disc in the hardware device 14. The Desktop style application 124 transmits the command to the hardware device 14, completes the appropriate action, such as reading the data from the disc and encrypting the data, and returns the result to the Metro style application 112 through the Windows API based network communication module 122.

In practice, the user of the computer 10 can open both the Metro style application 112 and its corresponding Desktop style application 124 manually, or the user can simply open only the Metro style application 112, which will in turn automatically open the corresponding Desktop style application 124.

When the Metro style application 112 needs to access the hardware device 14, such as to send a command to read data from a DVD disc, the Metro style application 112 sends a command to the Desktop style application 124 via the Windows API based network communication module 122. The Metro style application 112 then waits for the Desktop style application 124 to return the results of the command. The Metro style application 112 will then execute follow-up processes such as decoding the received data and displaying the data to the user through the display 18.

In the present invention, a set of custom communication protocols maybe defined to govern the communication between the Metro style application 112 and the Desktop style application 124. Once the Metro style application 112 and the Desktop style application 124 establish a network connection via the Windows API based network communication module 122, the Metro style application 112 and the Desktop style application 124 can exchange data. In this situation, the Desktop style application 124 is acting like a server to send data to and receive data from the Metro style application 112 in response to commands from the Metro style application 112.

When sensitive data is being exchanged, such as certain encryption keys, certificates, and premium data, the data needs to be encrypted before transmission. Before the actual data is exchanged, the Metro style application 112 and the Desktop style application 124 can perform authentication by generating an encryption key with key exchange technology. In this case, the encryption key is only known by the Metro style application 112 and the Desktop style application 124. The encryption key is used to encrypt the transmitted data. This encryption step is represented by the encryption step 105 shown in FIG. 4, although the encryption step may take place within the Metro style application 112 and within the Desktop style application 124 if desired.

The specific protocol and data transmission structure used in the present invention can be defined as necessary in order to allow maximum flexibility for using the approach for a wide variety of hardware devices such as a DVD drive, other types of optical disc drives such as a Blu-ray drive, a TV tuner card, other types of peripheral devices, and so on.

In summary, the present invention method provides a Desktop mode application that corresponds to a Metro user interface mode application. The Desktop mode application has permission to access hardware devices which the Metro user interface mode application does not have permission to access. Therefore, the Metro user interface mode application can access the hardware devices of the computer through the corresponding Desktop mode application. In this way, Metro style applications may have full access to hardware devices of the computer.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of accessing a hardware device in a computer, the method comprising:
executing a Metro user interface mode application in an operating system;
executing a Desktop mode application in the operating system, the Desktop mode application corresponding to the Metro user interface mode application, and the Desktop mode application having permission to access a hardware device of the computer that the Metro user interface mode application does not have permission to access;
the Metro user interface mode application sending commands to the Desktop mode application through a network application programming interface (API), and the Desktop mode application sending the commands to the hardware device for controlling the hardware device with the commands; and
the Desktop mode application receiving data from the hardware device and transferring the received data to the Metro user interface mode application.

2. The method of claim 1, further comprising:
encrypting data transmitted between the Metro user interface mode application and the Desktop mode application.

3. The method of claim 2, wherein encrypting data transmitted between the Metro user interface mode application and the Desktop mode application comprises:
utilizing an encryption key to encrypt the data before the data is transmitted between the Metro user interface mode application and the Desktop mode application; and
utilizing the encryption key to decrypt the data after the data is transmitted between the Metro user interface mode application and the Desktop mode application.

4. The method of claim 1, further comprising:
authenticating communication between the Metro user interface mode application and the Desktop mode application before sending the commands from the Metro user interface mode application to the Desktop mode application; and
generating an encryption key with key exchange technology, wherein the encryption key is only known by the Metro user interface mode application and the Desktop mode application.

5. The method of claim 1, wherein the Desktop mode application is manually executed by a user of the computer.

6. The method of claim 1, wherein the Desktop mode application is automatically executed by the Metro user interface mode application when the Metro user interface mode application is executed.

7. The method of claim 1, wherein the hardware device is an optical disc drive.

8. The method of claim 7, wherein the optical disc drive is a digital versatile disc (DVD) drive.

9. The method of claim 1, wherein the hardware device is a television tuner card.

10. The method of claim 1, wherein the hardware device is a peripheral device.

11. The method of claim 1, wherein the operating system is the Windows 8 operating system produced by Microsoft Corporation.

12. A computer for providing access to a hardware device in the computer, the computer comprising:
a memory;
a hardware device;
an operating system of the computer stored in the memory;
a user interface of the operating system comprising a Metro user interface mode application and a Desktop mode application, the Desktop mode application corresponding to the Metro user interface mode application, and the Desktop mode application having permission to access the hardware device that the Metro user interface mode application does not have permission to access; and
a processor executing the Metro user interface mode application, executing the Desktop mode application, controlling the Metro user interface mode application to send commands to the Desktop mode application through a network application programming interface (API), controlling the Desktop mode application to send the commands to the hardware device for controlling the hardware device with the commands, and controlling the Desktop mode application to receive data from the hardware device and transfer the received data to the Metro user interface mode application.

13. The computer of claim 12, wherein the processor encrypts data transmitted between the Metro user interface mode application and the Desktop mode application.

14. The computer of claim 13, wherein when encrypting data transmitted between the Metro user interface mode application and the Desktop mode application, the processor utilizes an encryption key to encrypt the data before the data is transmitted between the Metro user interface mode application and the Desktop mode application, and utilizes the encryption key to decrypt the data after the data is transmitted between the Metro user interface mode application and the Desktop mode application.

15. The computer of claim 12, wherein the processor authenticates communication between the Metro user interface mode application and the Desktop mode application before sending the commands from the Metro user interface mode application to the Desktop mode application, and the processor generates an encryption key with key exchange technology, wherein the encryption key is only known by the Metro user interface mode application and the Desktop mode application.

16. The computer of claim 12, wherein executing the Desktop mode application is manually initiated by a user of the computer.

17. The computer of claim 12, wherein executing the Desktop mode application is automatically initiated by the Metro user interface mode application when execution of the Metro user interface mode application is initiated by a user of the computer.

18. The computer of claim 12, wherein the hardware device is an optical disc drive.

19. The computer of claim 18, wherein the optical disc drive is a digital versatile disc (DVD) drive.

20. The computer of claim 12, wherein the hardware device is a television tuner card.

21. The computer of claim 12, wherein the hardware device is a peripheral device.

22. The computer of claim 12, wherein the operating system is the Windows 8 operating system produced by Microsoft Corporation.
